(19) United States
(12) Patent Application Publication
(10) Pub. No.: US 2002/0080983 A1
(43) Pub. Date: Jun. 27, 2002

(54) Optical microphone element and optical microphone

(75) Inventors: Alexander Paritsky, Modiin (IL); Alexander Kots, Ashdod (IL); Kazuo Takahashi, Tokyo (JP); Okihiro Kobayashi, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PHONE-OR LTD.

(21) Appl. No.: 09/881,944

(22) Filed: Jun. 15, 2001

(30) Foreign Application Priority Data
Oct. 15, 1999 (JP) 11-294221
Oct. 15, 1999 (JP) 11-294223

(51) Int. Cl. H04R 3/00; H04R 25/00

(52) U.S. Cl. 381/172; 381/92; 381/170

(57) ABSTRACT

An optical microphone element comprising a diaphragm (31) vibrating with sound pressure, a case (40) containing the diaphragm (31) and having first and second openings (38, 39) made in symmetric positions and facing the diaphragm (31), a light source (32) for irradiating the diaphragm (31) with a light beam, and a photodetector (35) for receiving the light beam reflected by the diaphragm (31) and outputting a signal corresponding to vibration of the diaphragm (31).

### CROSS-REFERENCES TO RELATED APPLICATIONS

International Publication No.: WO 01/28286 International Application No.: PCT/JP00/07162 International Application Date: Oct. 16, 2000 (10.16.2000) Priority No.: Japanese Patent Application No. 11-294221 Priority Date: Oct. 15, 1999 (10.15.1999) JP

### BACKGROUND OF THE INVENTION

1. Technical Field

This invention relates in an optical microphone device which uses an optical microphone element, and it is related to the optical microphone element and the optical microphone device that have excellent noise decrease characteristics.

1. Description of the Related Art

A general microphone has a fault that a wind pressure causes a noise and obstructs a call when used in a motorcycle or windy environment. Japanese Patent Publication No. 58-36879 discloses a microphone device for noise prevention.

The microphone device disclosed here stores a microphone element in the frame inside of the body. A compressed foaming body with a consecutive bubble fills a back portion of the frame body and surroundings of the element. The forming body with a consecutive bubble also fills the space between an inside protection board with a hole provided in front of the microphone element and an outside protection film with a hole provided in front of the frame body. On the edge of the frame body, a taper that spread out toward the front is formed. By covering the side and the back of the microphone element with foaming body as stated above, sensitivity becomes single directivity.

An electret microphone for decreasing noise shown in FIG. 7 and a dynamic microphone shown in FIG. 8 are known. FIG. 7 shows the structure of the electret microphone. FIG. 7A shows a front view, FIG. 7B shows a sectional side view, and FIG. 7C shows a rear view. The electret microphone stores in a body 10 a diaphragm 3 which oscillates by the sound pressure, and an electrostatic element 4 which converts the oscillation of the diaphragm 3 to an electric signal. In this structure, voice enters through an opening 1 provided in the front face 10a of the body. A small opening 2 is also provided in off site part of the back-plane 10b of the body 10.

FIG. 8 shows the structure of the dynamic microphone. FIG. 8A shows a sectional side view, and FIG. 8B shows a rear view. A magnet 21 having an opening is stored in a body 20, and a coil 22 is twisted around the magnet 21. A diaphragm 23 is set up in the front to confront the magnet 21. A small hall 23 is provided in the off site part in the back-plane 22b of the body 20 so that a little larger hole 24 may be connected to a hole of the magnet 21. A sound pressure gradation caused by an oscillation of a diaphragm 23 is detected as a gradation of magnetic flux density by the magnet 21 on which a coil 22 is twisted, and this is converted to an electric signal. In the conventional microphone device shown in FIG. 7 and FIG. 8, if the sound which enters through the front face and the sound which enters through the back-plane face are equivalent against the diaphragm, these sounds are canceled by each other, and the microphone doesn't take influence by the sound.

In the microphone device disclosed in Japanese Patent Publication 58-36879, and FIG. 7 and FIG. 8, there was a limit of noise decrease capability. Sound from the front face direction and sound from the back-plane direction did not reach in the diaphragm symmetrically. Therefore, a noise decrease effect was 5-7 dB at most, and a microphone device with increased S/N ratio is not realized. On the other hand, an optical microphone device has been noticed as a microphone device that may follow the variation of the weak sound wave, and that has the high sensitivity and wide-band characteristics which does not depend on a use environment.

FIG. 6 shows the structure of the head part of the conventional optical microphone device. A diaphragm 31 that oscillates by a sound wave is provided inside of the microphone head 30, and a surface 31a at the side that a sound wave hits is exposed in the outside. Therefore, a sound wave 37 that reached in this surface 31a oscillates the diaphragm 31. The space inside of the head 30 is divided to a portion facing a surface 31a and another portion facing an opposite surface 31b. In the portion facing the surface 31b, a light source 32 such as an LED irradiating a light beam in the surface 31b of the diaphragm 31 from a slant, a lens 33 to make a light beam from this light source 32 a predetermined beam diameter, a photodetector 35 which receives a reflection light reflected in the surface 31b, and a lens 34 to zoom a displacement of an optical path of the reflection light caused by the oscillation of the diaphragm 31 are provided.

In this structure, when a sound wave hits the surface 31a of the diaphragm 31, and a diaphragm 31 oscillates, a receiving position of the receiving surface 35a of the reflection light changes. If a photodetector 35 is composed as a position sensor, an electric signal that met the oscillation of the diaphragm 31 from the irradiation location of the reflection light is taken out. This is the basic structure of the optical microphone device. However, even such optical microphone device is used, a noise decrease effect can't be expected very much. This is because a diaphragm 31 oscillates by the noise which reaches a diaphragm 31 and this is piled as a noise signal by oscillation by the usual sound wave 37. Therefore, it is an object of this invention to provide an optical microphone device with energizing the characteristics of the optical microphone device, and to provide an optical microphone of high noise decrease effect.

### BRIEF SUMMARY OF THE INVENTION

The optical microphone element of this invention comprises: a diaphragm which oscillates by the sound pressure; a storage container which the diaphragm is stored in and which has a first opening and a second opening provided in symmetrical positions to each other and confront the diaphragm; a light source which irradiates a light beam in the diaphragm; and a photodetector that receives a reflection light of the light beam irradiated in the diaphragm and which outputs a signal coping with the oscillation of the diaphragm. Furthermore, in the optical microphone element of this invention, the diaphragm, the light source and the photodetector are arranged so that a directivity response pattern on the first opening side and a directivity response pattern on the second opening side may be symmetrical to each other. An optical microphone device of this invention comprises: the optical microphone element; a substrate which the optical microphone element is carried on; and a cover that covers the first opening and the second opening symmetrically toward the substrate so that the sound wave may go through; wherein the incidence of the sound wave through the cover via the first opening and the second opening is made equally.

### BRIEF DESCRIPTION OF THE DRAWINGS

FIG. 1 shows a structure of an optical microphone element of an embodiment of this invention. FIG. 2 shows an appearance figure of an optical microphone device of this invention. FIG. 3 shows a decomposition figure that shows the internal structure of the optical microphone device of this invention. FIG. 4 shows a directivity response pattern figure of the sensitivity of the optical microphone element of this invention. FIG. 5 shows a figure to explain the sound intensity of the microphone element put on the short distance field and the far range field. FIG. 6 shows a structure of the conventional optical microphone device. FIG. 7 shows a structure of the conventional electret microphone device. FIG. 8 shows a structure of the conventional dynamic microphone device. In these figures, 100 is optical microphone element, 40 is storage container, 31 is diaphragm, 32 is light source, 35 is photodetector, 38 is the first opening, 39 is the 2nd opening, 54 is cover and 50 is substrate.

### DESCRIPTION OF THE SPECIFIC EMBODIMENTS

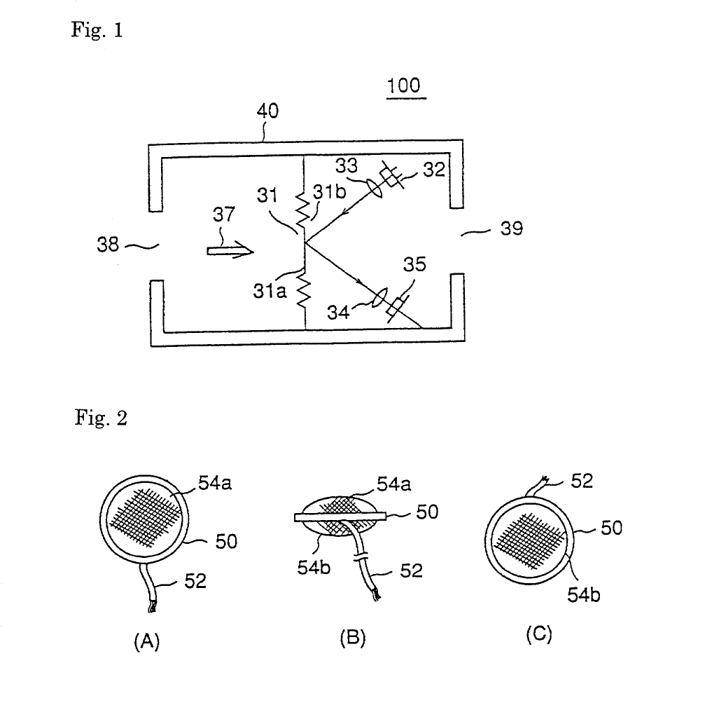

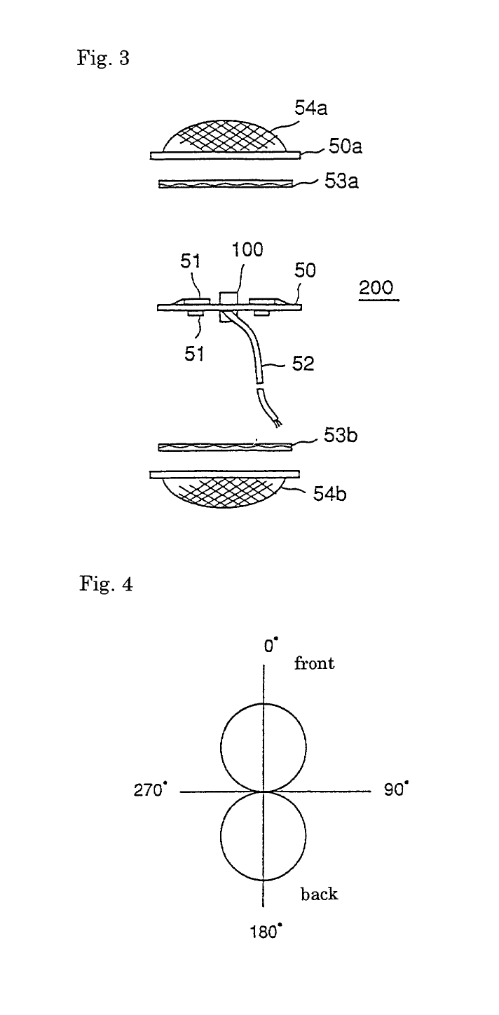

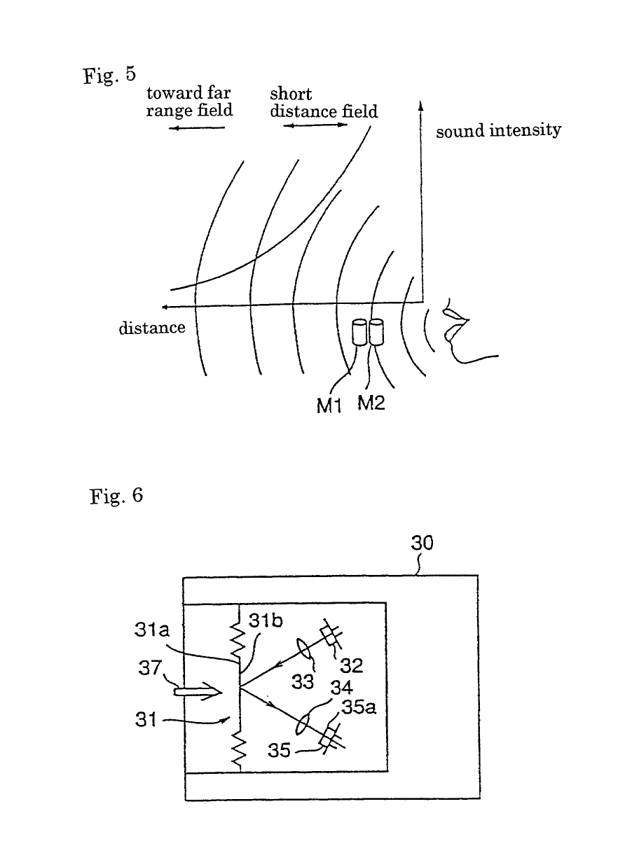

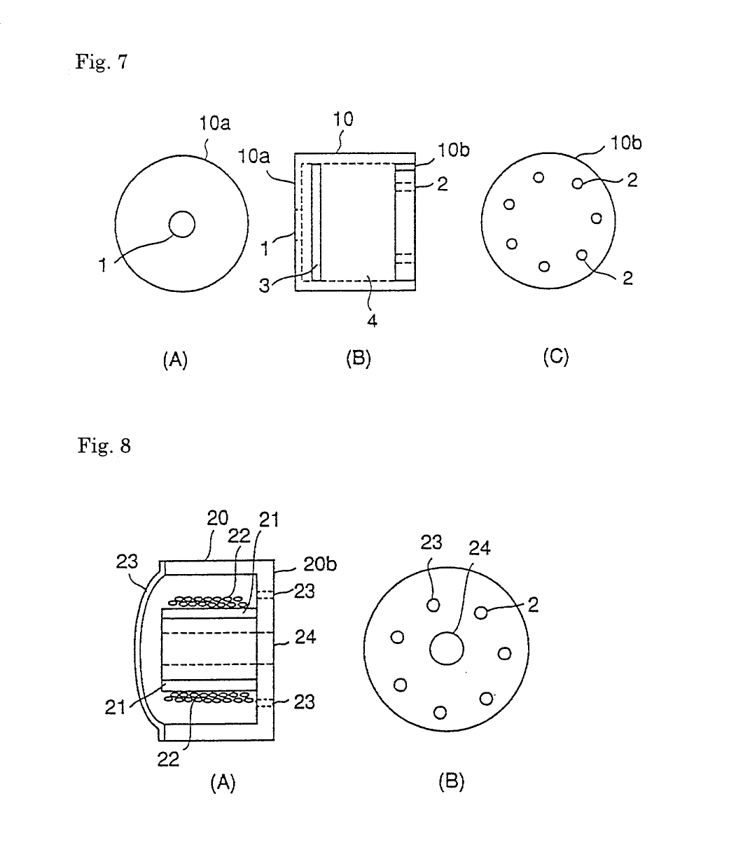

FIG. 1 shows a point part configuration of an optical microphone element 100 that relates for an embodiment of this invention. The same code is put to the same part with the conventional element shown in FIG. 6, and the detailed explanation is omitted. In the optical microphone element of the invention, a diaphragm 31 which oscillates by the sound wave 37 is provided in the central part of a storage container 40. Then, on both sides of the storage container, a 1st opening 38 and a 2nd opening 39 are set up to become symmetrical location to each other against a diaphragm 31. In this structure, a sound wave may enter from both openings into the storage container 40 to oscillate the diaphragm 31.

As stated above, in the optical microphone shown in FIG. 1, When a sound pressure of a sound wave from the 1st opening 38 and that from the 2nd opening 39 are equal, these two sound waves never oscillate a diaphragm 31 as they interfere each other on both sides 31a and 31b of the diaphragm 31. When two microphones that have equal sensitivities are arranged close and they receive sound wave which occurred in a far range, the two microphones detect the sound wave equally.

FIG. 5 shows a characteristic curve of the distance vs. sound intensity from the sound source. Generally, as shown in the figure, a sound wave occurs from the mouth of the person in a short distance from microphone element. In other words, most voice occurs at the short distance from this microphone element. The voice of the person of this short distance has globular field characteristics so that it may be shown by a circular curve. On the other hand, the sound wave that occurs in the far range such as the sound wave by the noise has the characteristics of the plane field. Although the sound intensity of the globular wave is about the same along the spherical surface or the envelope and changes along the radius of that glob, the sound intensity of the plane wave almost becomes the same at all the points.

Optical microphone shown in FIG. 1 can be thought to associate two microphones. Therefore, when this was put on the far range field, the sound waves which have almost the same intensity and phase characteristics from the 1st opening 38 and the 2nd opening 39 comes in the diaphragm 31, to interfere with each other, and those influences are decreased. On the other hand, as a sound wave from the short distance field enters from the 1st opening 38 and the 2nd opening 39 non-uniformly, a sound wave from the short distance field oscillates a diaphragm 31, and it is taken out as a signal by the photodetector 35.

FIG. 4 shows the directivity response pattern of the sensitivity of the optical microphone shown in FIG. 1. The optical microphone shown in FIG. 1 has almost “8” shaped symmetrical directivity comprising a pattern in the front face direction to go to the 1st opening 38 and a pattern in the back-plane direction to go to the 2nd opening 39. When the optical microphone shown in FIG. 1 is used, noise such as surroundings noise is imputed as sound from the far range field as shown in FIG. 5. In this case, as the sound wave enters equally from the 1st opening 38 and the 2nd opening 39 and interferes on the diaphragm 31 to extinct, a diaphragm 31 is never oscillated.

On the other hand, voice from the speaking person is inputted as sound from the short distance field. Therefore, reception sensitivities in two microphone elements M1, M2 are different to each other as shown in FIG. 5. Id est, the sound which enters from the 1st opening 38 and the sound from the 2nd opening 39 are different in intensity, and a diaphragm 31 is oscillated. Thus an optical microphone which decreased the influences of the noise can be realized.

FIG. 2 is an appearance figure which shows the point part configuration of the optical microphone device which the optical microphone 200 in FIG. 1 was carried on. FIG. 2A shows a front view, FIG. 2B shows a side elevation view, and FIG. 2C shows a rear view. FIG. 3 is the decomposition figure that shows internal structure. Referring to FIG. 2 and FIG. 3, the configuration of the optical microphone device using an optical microphone is explained. The optical microphone 200 shown in FIG. 1 is put almost on the center of the printed board 50. The optical microphone 200 is put on the printed board 50 so that the 1st opening 38 may face upward and the 2nd opening 39 may face downward. In this structure, the optical microphone 200 achieve the directivity response pattern of the equal sensitivity in top and bottom as shown in FIG. 4.

An off site circuit 51 to drive this optical microphone 200 is arranged on both surface of the printed board 50 to surround the optical microphone 200. To the substrate 50, cable 52 for microphone output and powering is connected. The printed board 50 with sponges 53a, 53b on top and bottom is covered by a net-shaped cover 54a, 54b. By fixing this, the optical microphone device is made. When the optical microphone device is put in the far range field, a sound wave reaches a diaphragm equally through the net cover 54a, 54b. When the optical microphone device is put in the short distance field, a sound wave enters un-equally to oscillate the diaphragm and achieve amplification output.

As explained above, the optical microphone device and the optical microphone element of this invention have the structure that a sound wave comes from the openings set up in symmetrical location against the diaphragm. In this structure, a sound wave such as noise from the far range field is cancelled and a sound wave from the short distance field is amplified and outputted. Therefore, an audio device that remarkably decreased the influences of the noise can be realized.

What is claimed is:

1. An optical microphone element comprising:
a diaphragm which oscillates by a sound pressure;
a storage container which the diaphragm is stored in and which has a first opening and a second opening provided in symmetrical positions to each other and confront the diaphragm;
a light source which irradiates a light beam in the diaphragm; and
a photodetector that receives a reflection light of the light beam irradiated in the diaphragm and which outputs a signal coping with the oscillation of the diaphragm.

2. The optical microphone element according to claim 1,
wherein the diaphragm, the light source and the photodetector are arranged so that a directivity response pattern on the first opening side and a directivity response pattern on the second opening side may be symmetric to each other.

3. An optical microphone device comprising:
the optical microphone element according to claim 1;
a substrate which the optical microphone element is carried on; and
a cover that covers the first opening and the second opening symmetrically toward the substrate so that the sound wave may go through;
wherein the incidence of the sound wave through the cover via the first opening and the second opening is made equally.
